(19) United States
(12) Patent Application Publication
(10) Pub. No.: US 2009/0176312 A1
(43) Pub. Date: Jul. 9, 2009

(54) BIOLOGICAL AND CHEMICAL TEST MEDIA AND SYSTEM

(76) Inventor: Richard H. Selinfreund, Deer Lake, IN (US)

Correspondence Address: KELLEY DRYE & WARREN LLP, 400 ALTLANTIC STREET , 13TH FLOOR, STAMFORD, CT, 06901, US

(21) Appl. No.: 12/327,612

(22) Filed: Dec. 3, 2008

Related U.S. Application Data
(60) Provisional application No. 60/992,277, filed on Dec. 4, 2007.
(60) Provisional application No. 61/025,203, filed on Jan. 31, 2008.
(60) Provisional application No. 61/025,943, filed on Feb. 4, 2008.
(60) Provisional application No. 61/036,194, filed on Mar. 13, 2008.
(60) Provisional application No. 61/061,083, filed on Jun. 12, 2008.
(60) Provisional application No. 61/094,356, filed on Sep. 4, 2008.

(51) Int. Cl. G01N 21/00; B05D 3/00

(52) U.S. Cl. 436/164; 422/82.05; 427/2.13

(57) ABSTRACT

An apparatus and method for performing medical, biological or chemical tests in the field is Disclosed. In some embodiments, the test media comprises a special purpose optical disc which is read, after application of the test specimen and subsequent processing using commonly available CD, DVD, High Definition DVD or Blu-Ray optical disc players.

### RELATED DOCUMENTS

This non-provisional U.S. Patent Application claims the benefit of priority from U.S. Provisional Patent Application No. 60/992,277 filed Dec 4, 2007, U.S. Provisional Patent Application No. 60/015,125 filed Dec 19, 2007, U.S. Provisional Patent Application No. 61/025,203 filed Jan. 31, 2008, U.S. Provisional Patent Application No. 61/025,943 filed Feb. 4, 2008, U.S. Provisional Patent Application No. 61/036,194 filed Mar. 13, 2008, U.S. Provisional Patent Application No. 61/061,083 filed Jun. 12, 2008, and U.S. Provisional Patent Application No. 61/094,356 filed Sep. 4, 2008. The disclosure of each such application is hereby incorporated by reference in its entirety where appropriate for teaching of additional or alternative details, features, and/or technical background, and priority is asserted from each.

### BACKGROUND

Conventional medical, biological and chemical testing often requires the delivery of a sample specimen to specialized laboratory testing facility. In some cases, such testing laboratories are not available within the constraints of available time, cost or distance. For some limited applications, portable test kits have become available for in-field use. Many test applications do not, however, lend themselves to cost effective currently available in-field testing configurations. In some cases, the test materials and/or chemicals are extremely expensive effectively precluding their use under field conditions, and in other cases, in-field tests are not available owing to expensive instrumentation necessary to read a test result.

More and more Americans are assessing their personal health in the privacy of their own homes, using oral swabs, tears, a few drops of blood, or a urine sample to test for blood glucose levels, cholesterol levels, markers for colon cancer, and markers for rectal cancer. These tests generally indicate the health status of the user, at least with respect to the single physiological marker tested, and provide evidence so that the user can make private, health-related decisions concerning his her health. The “at-home diagnostic market” (which only includes test kits that reveal results at home) has doubled since 1999, from roughly 2.9 billion dollars in world wide sales to greater than $6 billion in 2005. Globally, the Point-of-Care market is estimated at 33.6 billion in 2007 with the United States market representing the largest portion.

A companion diagnostic is defined as a privately used, disposable device, for Point-of-Care and or in-home use, that provides immediate evidence relevant to the health status of the user. Such evidence may be found, for example, by measuring the levels of pertinent physiological substances in the blood, tears, urine, feces, saliva, mucus, or the exhaled breath of the user. It is preferable that such tests be non-invasive. that is upon sampling not penetrating the epithelial barrier of the user.

Desirable physiological variables that could be analyzed by a companion diagnostic are those that have been found to change in a known way or in concerted ways depending the health status of the user. One such test is for blood glucose level, a test that is commonly and routinely used. This is an invasive test, in that a blood sample must be obtained from the user. For diagnosis, any such measurement or combination of measurements needs to be compared with pre-existing diagnostic criteria for interpreting those measurements. A shortcoming of many of the currently available companion diagnostic devices is that only one physiological variable is analyzed at a time by these devices.

Over the past century, the prevalence of certain health concerns has increased in line with changes in eating habits and diet, working patterns, and lifestyle choices. The following is a listing of some of these concerns: diabetes, stress, ageing, bone health and osteoporosis, cancer, HIV, digestive health, external appearance, fatigue, fertility; and heart and cardiovascular health. Obesity is a national problem and is understood to be strongly related to lifestyle choices. Another particularly important, and immediate health concern of individuals, and the community as a whole, is diabetes mellitus. Lifestyle choices are expected to significantly affect the progression of diabetes.

Diabetes mellitus is of the juvenile (Type 1) or adult onset (Type 2) forms. In the Type 1 form, insufficient levels of insulin are produced by the Islet cells of the pancreas to enable glucose uptake by respiring cells. Type 1 Diabetes is also known as Insulin-Dependent Diabetes (IDD). In Type 2 Diabetes, insulin is produced by the pancreas at sufficient levels, but for other reasons blood glucose is not efficiently absorbed. Type 2 Diabetes is also known as Non-Insulin Dependent Diabetes (NIDD). With respect to the adult onset form, Type 2 Diabetes, obesity is known as a strong risk factor for developing the disease. The Type 1 form is a consequence of complicated immunological and auto-immunological factors. Generally, the degree, responsiveness to therapy, and severity of Type 1 Diabetes, Type 2 Diabetes, and obesity. and the interactions between these conditions, is referred to herein as “diabetic fitness”. An individual is more “diabetically fit” if the individual has greater physiological control over blood glucose levels, is more responsive to therapy, and is more responsive to dietary modifications.

A method for assessing the effects of lifestyle choices on the progression or subsidence of these conditions would be valuable. Convenient, private companion diagnostics would allow a user to make choices that will improve diabetic fitness and lifestyle, and over time modify those choices as desired, depending on a series of diagnostic assessments.

### SUMMARY

Embodiments disclosed herein include an apparatus and method for cost-effectively performing medical, biological or chemical tests in the field using commonly available CD, DVD, High Definition DVD or Blu-Ray optical disc players. In each case, the objective of the test is the detection of the presence or characteristic of a specified target compound. While many of the embodiments disclosed, are described with reference to medical testing, other embodiments may be applied to other areas such as, without limitation, biological testing, chemical testing, environmental testing, food safety and security monitoring.

Diagnostic Digital Media are media comprising indicia therein or thereon that may be converted by digital reader into digital data, and further comprising purposefully-applied test materials (associated with one or more portions of a medium) that have binding specificity for a particular analyte. The digital data on the Diagnostic Digital Media may include software instructions for causing a digital processor, such as a computer, to seek out information on those portions of the medium that are associated with the test materials pertaining to changes that may occur when a test material on the medium is exposed to a specimen that may contain an analyte. A Diagnostic digital medium 10 may comprise indicia that are optically-readable by an optical reader, as well as, at least one test material associated with one or more portions of the medium.

The analyte which is reactive with the test material on a Diagnostic digital medium 10 may be organic or inorganic. For example, the test material may have a binding affinity for an inorganic compound, such as (without limitation) lead or mercury, or the test material may have a binding affinity for an organic compound, such as (without limitation) a viral capsid, a DNA sequence, glucose, lactic acid etc.

In an embodiment, the test carrier may be provided wherein small portions of the surface of the optical disc are coated with a specialized test material. The optical properties of the test material are designed to change in response to the application of an analyte. The application to the sample to the test area, and the assay protocols may be controlled by a reaction chamber subject to internal software controls, external software controls, or a combination of internal and external software controls.

In one embodiment, the optical properties of the test material are designed to change in response to contact with the target analyte. Such test materials may be applied to an optical medium, which is read by an optical reader. An optical medium is a recording medium wherein recording occurs by changing the optical characteristics in/on portions of the medium. One conventional type of optical disc, comprises one or more substantially planar surfaces formed of a material such as polycarbonate. Data to be recorded on the surface of an optical medium may be pressed or etched into one of the planar surfaces forming irregularities in the surface and following a spiral track. The recorded surface may then be coated with a reflective material film. The recorded data is read from the disc by an optical reader. In operation the reader projects a spot of laser light, which follows the spiral track as the disc is rotated, reflecting the irregularities of the polycarbonate disc corresponding in turn to the recorded data. Conventionally, the reflected laser light from the reflective material film is detected by a photocell. The diameter of the laser spot may be determined in part by the wavelength of the light (e.g., certain CD, DVD and Blu-Ray lasers, for instance, operate at 780 nm, 650 nm, and 405 nm respectively).

In an embodiment of the present invention wherein the Diagnostic Digital Medium is an optical medium, such as an optical disc, the optical reader's laser beam may be used to measure the optical properties in the test area of the medium after contact with a purported analyte within a specimen, contact with reagents specific for the analyte and after incubation according to protocol conducted by the reaction chamber. The small size of the laser beam allows minimization of the area of the optical disc which must be coated with specialized test material. Specific reagents may comprise materials which, prior to application of the specimen to the material, are characterized by a first optical property state, but upon application of the analyte displays a second optical state to the laser reader. As an example, the first optical property state might be of such opacity that it blocks the propagation of light from the optical player's laser to the recorded data surface, however, upon application of an appropriate analyte the opacity may change allowing a portion of the light to propagate through the test material. The degree of propagation of the light through the test material maybe proportional to the concentration of analyte interacting with the reagents.

For many specific medical applications, the cost of the test material is a major expense driver. Minimization of the amount of test material is therefore an important consideration. By allowing electronic detection of a change, less material may be needed (as opposed to if the change had to be humanly readable by the eye). In addition, some test protocols require multiple tests, using different test materials, to be performed on the same specimens. The Diagnostic Digital Medium can be advantageously utilized for the implementing numerous test protocols.

That is, a further embodiment provides for multiple tests to be performed using a single optical medium. Separate portions of the optical medium may be coated with, or interned with, different formulations of specialized reagents which respond to separate analytes. The results of the individual tests may be combined, by means of a software implemented Algorithm, to provide a composite diagnosis (such as a patient likely has diabetes, or a water sample contains hazardous levels of lead and mercury).

In an embodiment the Diagnostic Digital Medium has incorporated thereon, software that is configured to cause the reader or a processor connected to the reader to transmit data pertaining to the read at one or more test material sites associated with the medium, to a remote site over a wide area network, such as the internet, along with information pertaining to the IP address of the transmitter. The remote site then may process the information at said one or more test material sites and transmit to the transmitter's IP site a tentative diagnosis and or transmit a tentative diagnosis to a health professional or other professional (such as a water treatment expert) designated by the transmitter.

In an embodiment, the reaction chamber is designed to facilitate and enhance a signal corresponding to reaction of an analyte in a specimen with the test material on the Diagnostic Digital Medium so as to make it detectable by a reader, which may be a common optical disc reader, for example. This ‘detectable signal’ represents a combination of events associated with the contact or change in proximity of the analyte to the reagent. These events comprise binding, diluting, concentrating, chemically reacting the analyte with the reagent and/or secondary reagents to yield a detectable signal. Of the chemical processes involved, the reaction chamber permits maximization of signal production by manipulating both the thermodynamic and kinetic properties of the reaction components needed to produce a detectable signal. These include temperature control and the additions of catalysts such as metals and enzymes to reduce activation energies. This flexibility allows laboratory-like physical and chemical manipulation in a home or doctor's office, and therefore, vastly expanding the range on analytes and samples suitable for analysis.

Reaction chamber embodiments described herein provide a means to carry out a multi-step protocol needed to enhance the signal produced by a specific analyte or analytes in a sample on a test substrate comprising optical discs. The objective of the test is the detection of a specified target analyte. While many of the embodiments disclosed are described with reference to medical testing, equivalent embodiments may be applied to other areas such as, without limitation, biological testing, chemical testing, environmental testing; food safety, forensic and security monitoring.

In an embodiment the specimen is applied to that portion or portions of the disc surface having the test material. If the specimen contains the targeted analyte, a property of the test material may change, for example there maybe flouresence or a change in optical state from a first optical state to a second optical state. The change optical state might affect read of data under the test material, such that data readability is used to determine the presence or absence of the analyte.

In an embodiment, the surface coatings may be applied to the optical discs using high speed low cost printing techniques.

In an embodiment the Diagnostic Digital Medium is an optical medium readable by an optical reader that has test materials that alter state when exposed to physiological materials, such as saliva. The optical medium contains instruction code designed to check the position where one or more test materials are located on the optical medium and the state of the materials. The state of the materials may be adjudged by detecting optical changes in the test material, or in data which may be associated with the test materials (e.g., the test material lying over data indicia and changing the read of the data indicia when the state of the test material changes). Based on the state of such one or more test materials, the instruction set follows a predetermined algorithm to output a signal indicative of the health or physiological condition of the person using the companion diagnostic device. In one case, the instruction set is designed such that the person may make inquiry with respect to one or more physiological conditions (e.g., do the test material states indicate that I may have diabetes? PKU? a vitamin deficiency of some essential vitamin?), or physiological parameters (e.g., blood glucose level, metabolic pH state, etc.) The instructions on the medium may cause display to the user of the companion device alone on, for example, a display attached to the optical reader. Of course, the optical reader may be a standard CD or DVD drive, and the display may be a monitor attached to a processor (such as a computer) which processes the instructions on the optical medium and acts according to such instructions. The instructions on the optical medium may include instructions to send information over a communication path, as for example, a widely disseminated network system such as the Internet, to a remote site (such as a health practitioner's office).

While the Diagnostic Digital Medium in such embodiment is an optical medium, of course, any readable medium may be employed as long as the reader of the medium can detect changes caused by a change in the test material when exposed to the physiological tissue to which is exposed (e.g., saliva, urine, blood, feces, skin cells, hair, etc.). Multiple test materials may be associated with the medium with the patient selecting the condition or physiological status which the patient desires to be monitored. For example, test materials on the medium may be used to monitor one or more conditions or physiological state e.g. diabetes, heart health, exercise induced acidosis, bacteremia. The affect of the tissue on more than one test material may be need to for the program to provide tentative diagnostic output, or physiological parameter monitoring. For example, change in one test material may indicate acidosis, while change in another test material may relate to an abnormal glucose level. Changes in both may be need to make a tentative diagnosis of a certain condition.

In another embodiment the Diagnostic Digital Medium is a simple test strip which allows visualization by the patient of changes with the patient comparing to a standard visual chart for determining whether a parameter is change. In another embodiment, the Diagnostic Digital Medium is a device having locations on the device associated with test materials. In such device, a change in the test materials may be detected by other than optical read of the location, such as a detection in change in electrical conductivity at the location (with conductivity, for example, being monitored by a processor programmed to check for conductivity at such location). In another embodiment, the companion diagnostic device includes a kit containing multiple strips, or containers housing the test material, with directions as to how to employ the kit to determine a condition or state. Tissue may be added to the strips or containers, with a reaction ensuing if tie material contains the correct analyte. The reaction itself may be readable by a patient (for example when the test material changes color when exposed to a corresponding analyte) or may require electronic read by an electronic read device (for example wherein the reaction causes a shift in wavelength absorption which is not in the visible range). The kit may include instructions for placing the material on an electronically readable medium having demarcated areas thereon for placement of the reacted materials (that is between the test material and the physiological tissue).

In one exemplary embodiment, the Diagnostic Digital Medium gives the user direct feed back on the user's diabetic fitness level over time. The device shows the effects of diet and food choices made by the user by providing a plurality of physiological measurements in the form of a test panel. The panel of tests can show dietary metabolites that are adjudged positive or negative markers for a diabetic diet. In one exemplary embodiment a panel of markers helps the user make advantageous food choices for the user. When the Diagnostic Digital Medium is readable by a device connected or connectable to a networked system, the Diagnostic Digital Medium Diagnostic Digital Medium may send information about the panel of tests to a remote location for analysis. On the other hand, analysis may be made on site by use of algorithms associated with the Diagnostic Digital Medium or the device upon which the Diagnostic Digital Medium is read.

The Diagnostic Digital Medium may or may not be reusable, depending upon whether the test material is changed in a reversible or non-reversible manner. A patient in any case may monitor daily, multiple times per week weekly, monthly etc. for a condition or physiological parameter and send the information to a remote location, or storage the information in a database proximate to the patient, which such multiple data being useful for determine how a patient's lifestyle is affecting their health. The latter may provide physician's and patients with more accurate information than would be obtained relying on oral history based on recollection. Further, monitoring in such manner may lower long term cost to a patient, by allowing lifestyle problems to be identified early. Many conditions are reversible if detected early.

In one case, diabetes and endothelial dysfunction associated with the pathogenesis of both micro and macroangiopathy in diabetes are monitored. Markers for endothelial dysfunction may include von Willebrand factor, and vascular cell adhesion molecules. Markers for vascular disease damage and diabetes progression may serve as early markers for disease progression for both states (see, K. Tan, Proceedings of the 13^{th} International Atherosclerosis Symposium vol. 1262, May 2004 pp 511-514). Earlier markers which may be monitored for endothelial dysfunction and diabetes may include: LDL, HDL, Cholesterol, C-reactive protein (CRP), nitric oxide levels, soluble intracellular adhesion molecule 1 (s1Cam-1) and PAIL and endothelin 1, many of which such markers have been found by the present inventors to be present in saliva. Other markers that may be monitored may be triglycerides. in saliva or blood or ratio levels, such as HDL/LDL level. One or more of such makers may be used for early detection of diabetes or vascular disease, or other conditions. For example, endothelial dysfunction has been associated with the pathogenesis of both micro and macroangiopathy in diabetes and may be demonstrated in patients with type q and type 2diabetes mellitus. Markers for endothelial dysfunction (e.g. von Willebrand factor, vascular cell adhesion molecules) may be elevated in patients with diabetes. Thus the same markers for vascular disease damage and diabetes progression may serve as early markers for disease progression for both states (K. Tan, Proceedings of the 13^{th} International Atherosclerosis Symposium Vol. 1262, May 2004 pp. 511-514). In early onset diabetes patients may not have abnormal blood sugars, but may have elevated markers for blood vessel inflammation. These patients may be detected even though they have not yet developed clinical diabetes.

In one embodiment, a test sample is obtained using an oral swab. In another embodiment, a test sample is obtained by exhaling into a collection device which has material for absorbing the exhaled air or component thereof.

In one embodiment, the Diagnostic Digital Medium provides results in near real time in the user's residence. In yet another embodiment, the test sample is transmitted to a testing center, from which test results are obtained on a timely, confidential basis,

Feedback may also be provided on the affect lifestyle is having on a patient. For example, the diabetic state may in some cases be controlled by diet and exercise. By adequately monitoring the condition of the patient over time, long term cost for diabetes care may be reduced, for example by the prevention of the progression of vascular disease.

Examples of relevant physiological markers suitable for a companion diagnostic directed to diabetic fitness are: insulin level, catecholamine status, triglyceride level, carbohydrate level, respiration quotient, as well as genetic markers, such a Nhe-1, that suggest a susceptibility to Type 1 Diabetes.

Generally, when a sample is analyzed. a plurality of tests are performed on the sample and a panel of test results obtained. To evaluate the significance of the results, the test panel is then compared to pre-existing diagnostic or performance criteria for those results. It is also envisioned that the test results may be interpreted independently by the user, if desired. based on the user's personal preferences, experiences and perceptions of the significance of the test results.

It is further envisioned that testing by the instant invention is strictly non-invasive, and that independent, separate measurements of the user's blood glucose level, using methods known to artisans, would optionally supplement the panel of test results provided by the instant invention.

Diagnostic Digital Media have a heretofore unrecognized limitation in that the as designed the test material on a medium must react with analyte(s) to which test material is directed either in the ambient environment surrounding the Diagnostic Digital Medium, or the environment to which it is exposed upon read by a digital reader (e.g., optical reader). The present disclosure details a reaction chamber for Diagnostic Digital Media designed to greatly improve analyte/test-material interaction thereby greatly expanding the number of analytes of interest that can be probed using a Diagnostic Digital Medium. Such reaction chamber is configured to automatically alter conditions about a Diagnostic Digital Medium to greatly improve reactivity conditions between the test material and specimen applied to the medium if the test material contains the analyte of interest.

In an embodiment, the reaction chamber includes a processor and Diagnostic Digital Medium reader. The processor may be configured to detect which of a number of Diagnostic Digital Medium types have been placed into the reaction chamber. For example, the reaction chamber processor may be configured to detect from indicia associated with the Diagnostic Digital Medium what type of test material is associated with the Diagnostic Digital Medium. The processor may then alter conditions within the reaction chamber such that conditions within the reaction system favor reaction, or provide more favorable reaction conditions, of the test material with an analyte which may be found in a sample applied to the Diagnostic Digital Medium. Conditions that may be altered include, but are not limited to, temperature, cyclic temperature, relative humidity, light/dark exposure, and the types of materials materials within the ambient environment (such as solvents, reagents etc. being added to the environment surrounding the medium, or directly to the medium itself). When an appropriate digital reader is associated with the reaction chamber, the reaction chamber may play the role of the Digital Reader normally associated with a read of the Diagnostic Digital Medium, allowing the reaction chamber to both control conditions about the Diagnostic Digital Medium and/or add reagents to the Diagnostic Digital Medium after application of the sample to the Diagnostic Digital Medium. and to act as a reader of the treated Diagnostic Digital Medium having the sample. The digital reader coupled with processor in the reaction chamber, may in conjunction with software, cause transmission of information pertaining to changes in respect of the test material due to reactivity with the sample. Information may be transmitted directly to the person querying the Diagnostic Digital Medium (as for example, by way of a coupled display) or may be transmitted remotely, as for example, by way of a widely disseminated network (e.g., the Internet) to a remote site (e.g. a doctor's office, or testing lab) where, for example, the information may be interpreted to provide a tentative diagnosis.

In one embodiment the reaction chamber comprises a housing configured to receive and encompass a particular Diagnostic Digital Medium, e.g. a DVD or CD, such that the medium is enclosed within the chamber. In some embodiments, the reaction chamber is sealed or substantially sealed but includes an entrance port to allow the medium to be placed into the reaction chamber, and in some embodiments the reaction chamber comprises a top and bottom section that can be adjoined to make a sealed, or substantially sealed, chamber about the Diagnostic Digital Medium.

One reaction chamber embodiment includes external material application modules which are configured to hold materials and to allow for application of such materials into the reaction chamber. The materials may include, for example, materials that facilitate chemical reactions and or physical changes on the Diagnostic Digital Medium to yield and amplify a detectable, or more detectable, signal corresponding to the presence and amount of the analyte.

A reaction chamber may be designed to automatically execute multi-step protocols to change the environment about the Diagnostic Digital Medium. For example, the environmental conditions within the reaction chamber, and about the Diagnostic Digital Medium, may be altered over time such that reaction conditions may be optimized, or more fully optimized, to allow reactivity between a first test material on the medium and a potential analyte in the specimen, and then optimized, or more fully optimized, to allow reactivity between a second test material on the medium and its potential analyte in the specimen, and likewise, for a third test material that may be on the Diagnostic Digital Medium.

The Diagnostic Digital Medium may comprise a conventional medium, such as a DVD, BD or CD, wherein there is a large base of digital readers currently available. In such case, an embodiment reaction chamber may not include its own reader, but merely be used to optimize, or more fully optimize, the reactivity between a test material on the medium and the analyte being sought to react with the test material, and the Diagnostic Digital Medium removed and then read on the conventional reader.

In an exemplary embodiment the reaction chamber includes various components and modules. These include a reaction chamber housing which encloses Diagnostic Digital Medium, material addition modules, a temperature/relative humidity control unit, a processor controlling the control unit and material addition modules, and communication system allowing for input and output of data with respect to the processor.

In an exemplar use, a sample, for example, a blood sample, or a sample of a material (e.g. dissolved paint), is applied to an area of a Diagnostic Digital Medium and then placed into reaction housing chamber.

In an embodiment, once a Diagnostic Digital Medium is placed into the reaction chamber reagents specific for aiding the development of reactivity between the target analyte and the test material of the Diagnostic Digital Medium may be generally applied to the Diagnostic Digital Medium either indirectly by providing the same in the environment surrounding the medium, or directly by providing the same directly to the medium. In embodiments, the reagents may be applied specifically to the area associated with the test material. Application of the reagents may be by use of external and/or internal fluid modules operatively configured to apply reagent from one or more reservoirs. A door may be associated with reaction chamber configured to allow for easy transfer of Diagnostic Digital Medium to or from the substrate housing. Within the substrate housing, environmental conditions may be altered by, for example, application of reagents by external and/or internal fluidics modules, with wash or application cycles being monitored by a detector.

A reaction chamber may also comprise a power supply, one or more internal processors, data transfer lines, and a display. Internal processor(s) may be configured by software or hardware to cause a release of specified reagents from external and/or internal fluid modules, a change in temperature by activation of heater, vibration by activation of vibrator, a change in humidity by activation of humidifier, etc. Reaction chamber may also comprise a control module for receipt of signals pertaining to desired reaction conditions.

The sample may be applied to the Diagnostic Digital Medium either manually as for example by contacting the sample with the medium by dropper or by a swipe, or may be applied automatically as through a fluid device, such as internal sample fluid device operatively configured to take a sample and automatically dispense it appropriately onto the medium

The fluidics modules, whether external or internal, may be operatively configured to allow dispensing of fluids only after the Diagnostic Digital Medium has been properly inserted into the reaction chamber. In an embodiment, liquid or dissolved samples may be applied to the substrate with reagents specific for the target analyte. Alternatively the reagent maybe applied to the substrate after application of the sample that may contain the target analyte.

In one embodiment, wash steps are transacted by the reaction chamber. Washing steps may be applied through a fluid module. Such steps may in certain circumstances be necessary to prepare the sample for the reagent by removing sample components that compete (leading to interference and variable response) with the analyte for the specific reagent. Wash steps can also be designed to remove sample components that may poison the reagent. In some cases, the reagent may be prepared for, or activated by, the wash step. For example, very useful reactive reagents but with short half-lives, maybe generated by activation of the ret in this step and used because the nascent product is then applied to sample on the substrate without storage. A wash step, controlled by the fluidics module, may also be useful in terminating the reaction and/or terminating an intermediate reaction before initiating one or more secondary reactions need to produce a useful signal.

Optionally, filters or surface active materials may be placed in the sample and/or reagent-carrier lines to, for example, purify the sample, or activate the reagent, prior to contact of the reagents and sample. These filter or surface active materials include, without limitation, bonded silica, charcoal, ion exchange resins or antibodies fixed on solid surfaces.

The fluid modules may comprise precision microliter pumps, degassers, flow regulators, and viscosity adjusters to permit delivery of reagents. Such fluid module may dispense sample and or wash materials need to deliver a signal specific for the analyte and to be read by common devices such as such optical disc readers.

The reaction control module may be configured to control, sustain, and terminate the reaction on the substrate needed to produce and amplify a detectable analyte signal. These include temperature control in a constant manner or in a positive or negative gradient to a set point, or in a cycling manner similar to what is needed in polymerase chain reactions. Reaction control module may also be operatively configured to controls reaction time, mixing of reagents, control of reaction environment with respect to moisture content/pressure, purging of oxygen with inert gases such argon or helium as well as the content of reactive gases such as ozone needed to facilitate production of the analyte signal. Reaction control module may also control the mixing of reaction components by controlling the spinning or vibrating of the medium bearing the sample. Reaction control module may also be configured to control electromagnetic energy sources in the form of gamma radiation, x-ray, ultraviolet infra-red, micro wave and radio waves needed to initiate, sustain or terminate the reactions. A gamma radiation source may be of particular use for sterilizing components, substrates, and reagents prior to initiating the reaction. Reaction control module may also cause generation of micro waves which may be a useful means of precisely deactivating enzyme at a point in time. In enzyme-catalyzed reactions that also degrade the product this may be very useful. Micro wave deactivation of enzymes is of utility in multi-step reactions since the micro wave does not contribute an interfering substance to subsequent reactions.

User control of the various modules in the reaction chamber may be maintained either by an on-board computer or optionally with an external computer. By use of internal or external means, all steps and reaction conditions are set and recorded as a program of steps. Of course, step may be dictated by information or software found on the Diagnostic Digital Medium. Preprogrammed steps may also be exported or imported into Reaction Chamber, as for example, by way of the Internet. This is of particular interest with respect to uniformity of measurement and creating standard operating programs. For example, FDA-approved procedures maybe imported and utilized.

### BRIEF DESCRIPTION OF DRAWINGS

The following detailed description given by way of example, will be best understood in conjunction with the accompanying drawings in which:

FIG. 1 is an exemplary drawing of a suitable optical media a standard DVD disc. In this embodiment, the test material is contained in the area indicated by the oval on the read side of the disk. The specimen is applied to the oval area.

FIG. 2 is a simplified schematic drawing of an optical disc substrate incorporating test sites.

FIG. 3 is a simplified block diagram of the diagnosis system.

FIG. 4 is a simplified flow chart of the diagnosis process.

FIG. 5 is a diagrammatic depiction of an embodiment of the Reaction Chamber; and

FIG. 6 shows in illustrative form an exemplary methodology for detecting an analyte in a specimen using a Diagnostic Digital medium.

FIG. 7 is a cross-sectional view of an environmental monitoring disc.

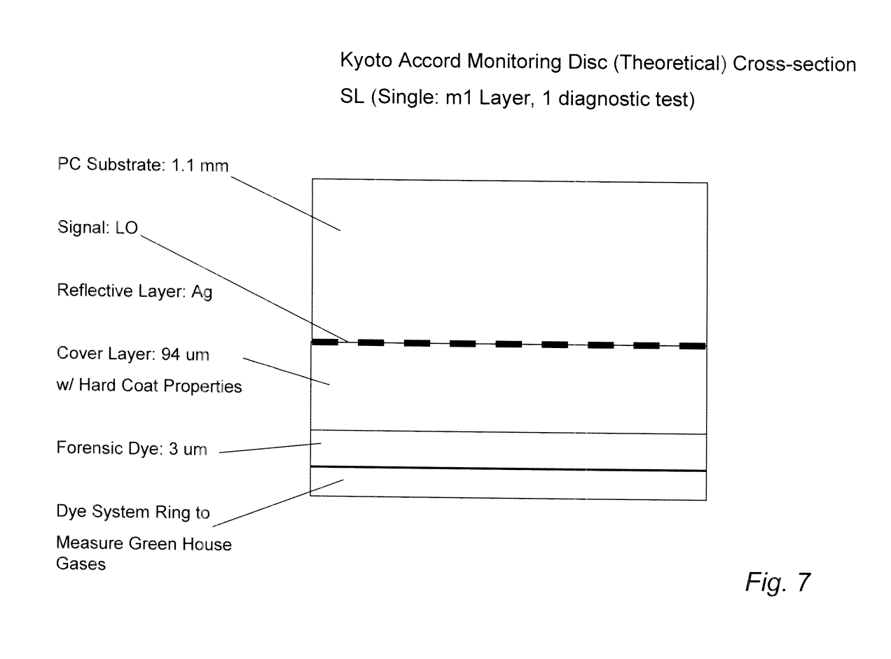

### DETAILED DESCRIPTION

Embodiments disclosed herein include an apparatus and method for cost-effectively performing medical, biological chemical and environmental tests in the field using commonly available optical media. $Wile medical and biological testing embodiments are disclosed in the following detailed description, other embodiments, suitable for environmental and chemical detection and analysis are included in the scope of the disclosure.

An optical medium is a recording medium wherein recording occurs by changing the optical characteristics in/on portions of the medium. For these test applications, one selected to change their optical property in response to a predefined test result. An optical reader may detect the changed optical property.

In conventional optical discs, data to be recorded on the surface may be pressed or etched into one of the planar surfaces forming irregularities in the surface and following a spiral track. The recorded surface is then coated with a reflective material film. An optical player reads the recorded data from the disc. In operation, the player projects a spot of laser light, which follows the spiral track as the disc is rotated, through the thickness of the polycarbonate disc. The laser light is reflected from the reflective material film and is detected by a photocell. The diameter of the laser spot is determined in part by the wavelength of the light. CD, DVD and Blu-Ray lasers. for instance, operate at 780 nm, 650 nm, and 405 nm respectively.

In one embodiment, the optical medium is provided in the form of a conventional optical disc which may be read by conventional CD, DVD, High Definition DVD or Blu-Ray optical readers or players. This provides the capability of using the extensive already installed base of optical players already on the market.

Additionally CDs, DVDs, High Definition DVDs or Blu-Ray discs containing a test material may be economically produced using current DVD production equipment including high speed disc surface printers.

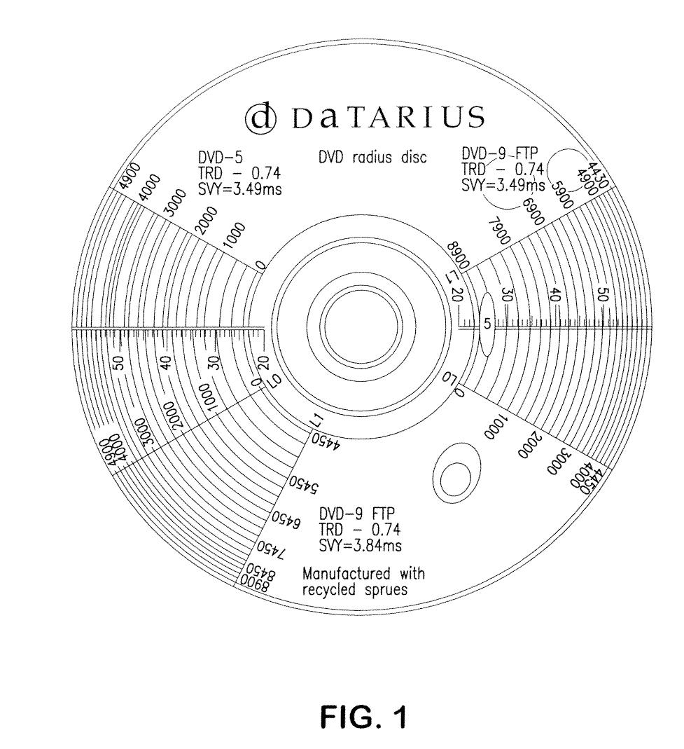

The printing of the test material may take place after a standard DVD/CD ROM is manufactured. The DVD/CD ROM may then be printed with test material containing MD (medical diagnosis) ink in a very specific area of the disc, for example in the lead in or read region of a DVD (FIG. 1).

Another embodiment includes the use of dyes that change color when acid is generated and is detected by reflectivity using light generated from various sources of wavelengths to include the entire electromagnetic spectrum depending on the change in absorbance, or other forms of optical state, of the dye caused by the analyte. Most commonly these include the lasers of wavelengths equal to 405 nm, 650 nm and 780 nm currently used in Blue Ray DVD, DVD and CD players respectively. Embodiments may also include detection of changes in the absorbance max that occur outside the visible range.

Test optical media applications include medical and home lifestyle monitoring. The general use may comprise applying a specimen to the test material area on the media (CD, DVD, Blu-Ray DVD) shown in the FIG. 1. This area contains the specialized test material which comprise reagents specific for the intended analyte or class of analytes and can include substances to facilitate a change in optical state such as an acid generating system and a dye. Of course, any parametric change which is capable of being detected by the reader of the optical medium may be employed. In one case, when the reagent designed for the specific analyte in the specialized test material engages the analyte, the acid generating system is activated changing the absorption maximum of the dye. Typically this change results in a change in optics that activates the DVD/CD player indicating the presence or absence of the analyte.

Once a specimen is applied to the test material spot containing the specific reagent needed for the intended analyte, a parametric change, such as in absorbance or in opacity may be monitored. The monitoring procedure may be implemented using software.

In another embodiment the optical medium comprises software that is configured to cause the reader or a processor connected to the reader to transmit data pertaining to the read at one or more test material sites associated with the medium, to a remote site over a wide area network, such as the interne, along with information pertaining to the IP address of the transmitter. The remote site then may process the information at said one or more test material sites and transmit to the transmitter's IP site a tentative diagnosis and/or transmit a tentative diagnosis to a health professional designated by the transmitter.

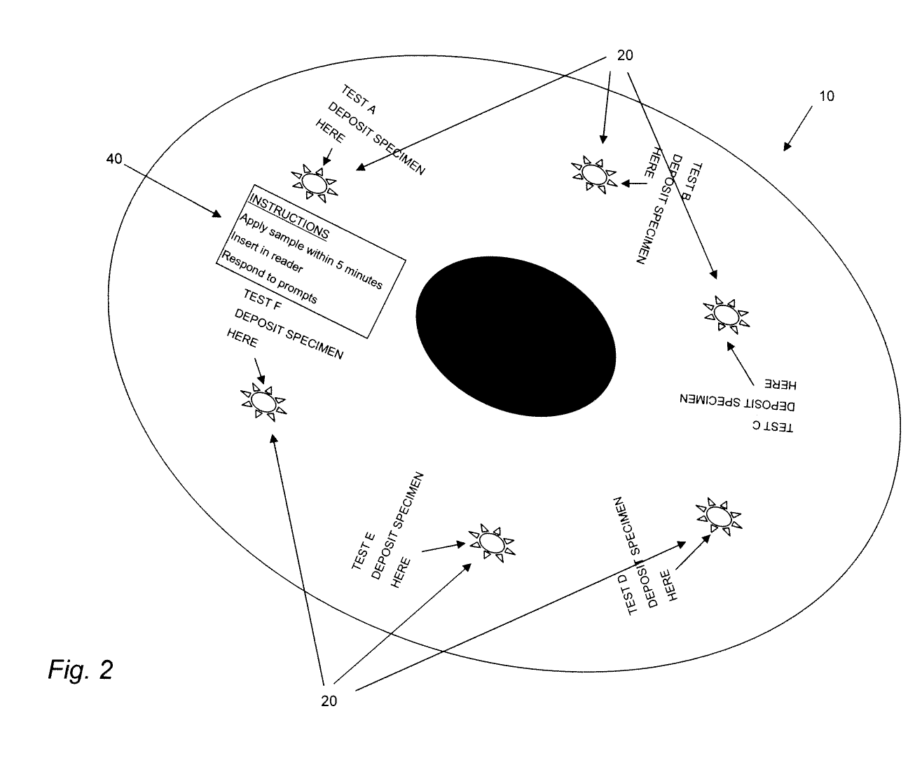

Embodiments of a system and method for implementing a set of physiological tests are also disclosed. An embodiment of the system comprises a substrate incorporating multiple test site locations 20, each of which is configured to receive a specified biological sample. In one embodiment, as shown in FIG. 2, the substrate may be a specially configured disc 10 readable by an optical disc reader 100. The system further comprises an optical disc reader 100 operatively connected to a computer 110. In an embodiment, the computer 110 may be configured to communicate via a network 140, such as the Internet, with other remotely located terminals 130.

The sample may be bodily fluid or tissue. Each test site may be configured to receive the appropriate sample type. Exemplary configurations may include a reservoir or liquid-absorbent medium for fluid samples, or an adhesive surface spot for non-fluid samples. A transparent cover layer may be provided to constrain the sample. The surface of the substrate may include printed text and or diagrams indicating the location of the test sites 20, and instructions 40 for application of the biological samples. The printed text may also include instructions for the submission of the substrate to the test system. Each test site location contains test material(s) which reacts with the specified biological sample in a predictable way, in response to the characteristics or condition of the sample. The selection of the specific test sites 20 may be based on forming a complementary set of tests useful in the diagnosis of a particular disease or condition.

In an embodiment, a biological sample may be applied to the substrate, immediately adjacent to the test site of the disc 10, at an indicated spot. Disc 10 may be inserted into optical disc reader 100 and spun. The radial force generated by the spinning action may be used to distribute the biological sample as an even film over the test site.

After application of the specified biological samples to each of the test sites 20, on a given substrate, the samples may be processed, as required, to execute the respective test. Alternatively, the biological samples may be treated before application to the test site (or before and after application to the test site). Execution of the test may require varying environmental conditions in a prescribed manner to obtain the desired results. Specifically, the varied environmental conditions may comprise temperature, humidity, pressure, exposure to reagents, exposure to light of specified wavelength, exposure to ionizing or non-ionizing radiation. or other agents. The necessary environmental conditions may automatically be provided by a test performance apparatus which receives the substrate, containing the applied biological samples, and executes the test according to a pre-programmed regimen for the test materials.

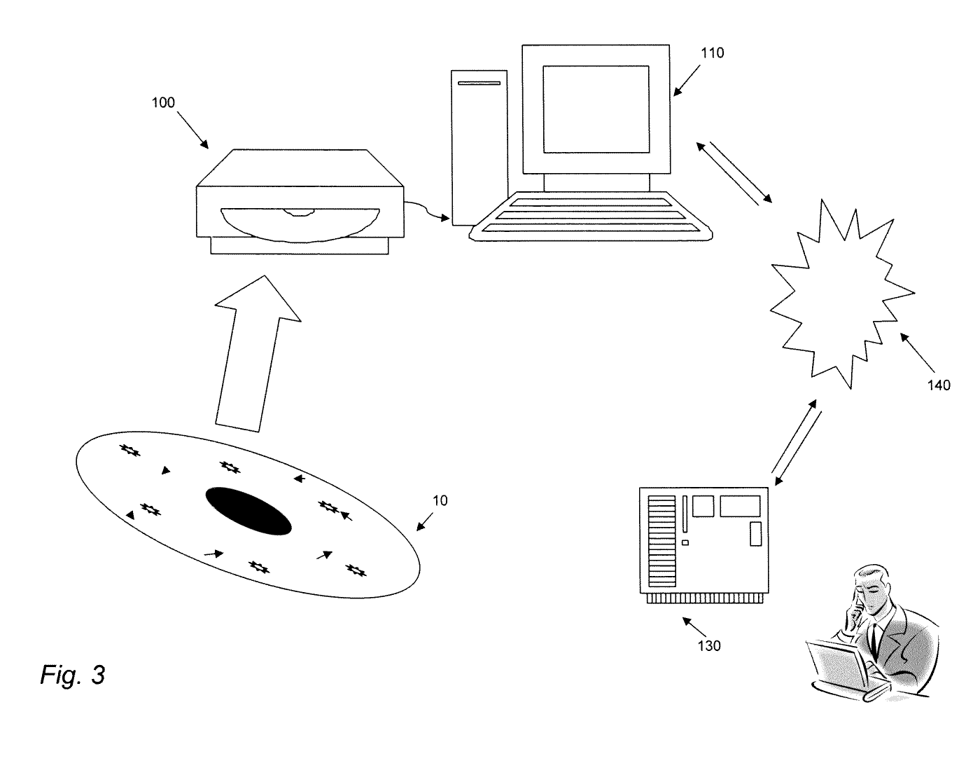

Each of test sites 20, at the conclusion of the test regimen, may manifest the test results in the form of a measurable change to the characteristics, of the sample and the reactive materials, at the test site. Exemplary changes may include changes in optical properties, magnetic properties. electrical properties, or other physically measurable characteristics. The measurable changes, resulting from the test procedure, may be detected and quantified by an automated test measurement apparatus. The test measurement apparatus may interrogate each of the test sites 20 and record the results of each of the tests. As shown in FIG. 3, in an embodiment, the function of test performance and the test measurement may be conducted by a single apparatus, under the control of a test processor 110.

The test measurement results may be combined with other patient-specific related data and condition- or disease-specific data to formulate a potential evaluation or diagnosis. For example, software may request information from the patient about physiological status, such as age, height, and family issues. In an embodiment, the formulation of the evaluation or diagnosis may be automatically performed by diagnosis software. Alternatively, the evaluation or diagnosis may be performed by a qualified practioner employing the results provided by the diagnosis computer or directly by the test measurement apparatus. The diagnosis computer may be co-located with the test system or, alternatively, at a remote location 130. For remote location implementation, communication between the test system and the diagnosis computer may be provided by suitable point to point or network means, such as the INTERNET 140, as is well known to those skilled in the art. In addition, the distribution of the results of the tests may be restricted by a password access system or other security means.

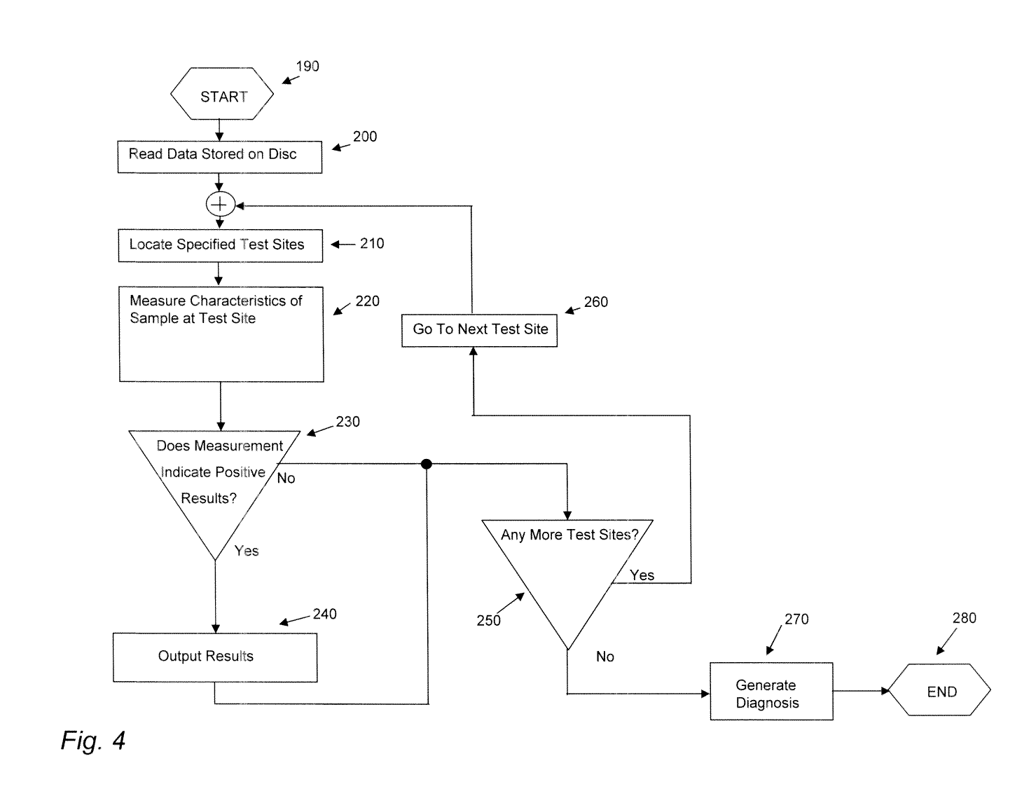

An embodiment system may be controlled by software implemented by a computer. FIG. 4 is a simplified flow diagram of a flowchart of an embodiment. The data stored on the disc 10 is read 200 by the disc reader 100. The first test site is located 210 by the disc reader 100. The characteristics of the sample at the test site are measured 220. If the measurement 220 provides positive results. the results are output 240. After the results are outputted, the process queries whether there are any more test sites 250. If the results are not positive, the process similarly queries whether there are any more test sites 250. If there are more test sites, the process goes to the next test site 260. If there are no more test sites, a diagnosis is generated 270, and the process is ended 280.

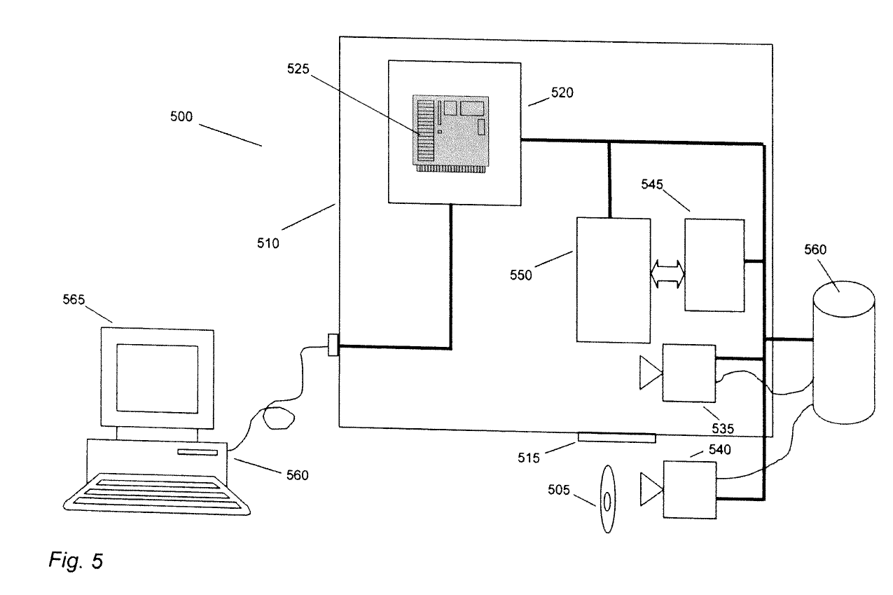

The system may comprise a reaction chamber to facilitate the test. FIG. 5 illustrates an exemplary reaction chamber 500 designed to optimize conditions for reaction between a purported analyte in a sample with a test material found on the Diagnostic Digital Medium 505. Exemplar reaction chamber 500 comprises a chamber housing 510 having a reception port 515 for receiving Diagnostic Digital Medium 505 into chamber housing 510. Exemplary reaction chamber 500 further includes a control module 520, which comprises a processor 525 configured to control operation of the reaction chamber 500 and various modules attached thereto. Control module 520 may be powered by power supply 530, which may also power interior fluid dispensing module(s) 535 and or exterior fluid dispensing module(s) 540, each attached to a reagent/sample reservoir 560 and operatively configured to dispense fluids to the environment about the Digital Optical Medium 505 or directly to the Digital Optical Medium 505 itself, when the medium has been inserted through reception port 515 and it is enclosed within chamber housing 510. Reaction chamber 500 may include therein condition monitor 545 that is configured to monitor conditions within reaction housing 550. Reaction chamber 500 may further include a communication port 555 designed to communicate with an external computer or processor 560. The external computer may be located in proximity or remote from the reaction chamber 500. The data may be communicated over a communication network such as the Internet and may also be displayed on a display 565.

In one embodiment, the Diagnostic Digital Medium is an optical medium provided in the form of a conventional optical disc which may be read by conventional CD, DVD, High Definition DVD or Blu-Ray optical readers or players. This provides the capability of using the extensive already installed base of optical players already on the market. Additionally CDs, DVDs, High Definition DVDs or Blu-Ray discs containing a test material may be economically produced using current DVD production equipment including high speed disc surface printers. In an optional aspect of such embodiments, portions of the planar surface of the medium, such as the read-side are coated with a test material that reactions in a predictable manner with an analyte which is to be detected. In one embodiment the test material may be printed using a VideoJet Excel UHS printer on the read side of the DVD ROM disc. The reagents that are dispensed by the Reaction Chamber via its internal or external fluid dispensing modules may be specific for the analyte of interest in which case instructions may be provided for which associating the correct reagent with the fluid dispensing modules. For example, in some cases, the analyte may need to initiate an acid generator molecules to change the optical state of the test material from, for example, opaque to transparent state

One exemplary embodiment formulation of the test material may comprise:

4-120 mg/ml reactive acid generator (the charge on the droplets being, in a range from 900 uSeimens/cm to 1800 uSeimens/cm).

2 mg/ml—16 ml/ml medical reactive dye.

3-5% of some water soluble binder used to increase viscosity to 2.0-4.0 cPoise.

95-98% of ethanol.

With the test area and reagents therein of such embodiment once the reagents contact, under conditions controlled by the reaction chamber, the analyte acid may be released resulting in the disc coating turning from blue (blocked read) to clear which can be read and analyzed by the player software.

In one embodiment, the reagents are employed as nanoparticles.

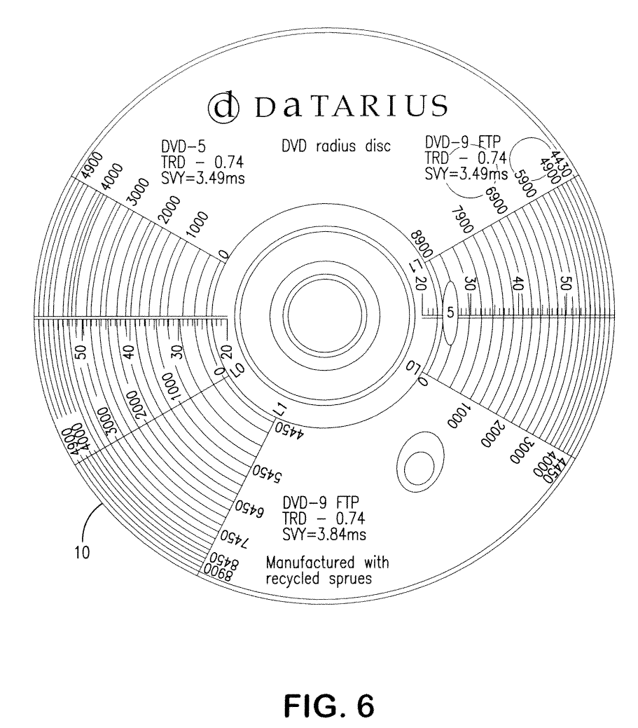

When application of the test material is to the surface of an optical medium, the printing of the test material may take place after the medium, such as a standard DVD/CD ROM, is manufactured. The DVD/CD ROM may then be printed with test material containing MDs (medical diagnostic) ink in a very specific area 5 of the disc 10, for example in the lead in or read region of a DVD (FIG. 6).

Another embodiment includes the use of test materials, such as dyes, that change color when acid is generated. Change in color may be detected by reflectivity using light generated from various sources of wavelengths, by which it is meant to include the entire electromagnetic spectrum (with matching of change in color with light wavelength depending on the change in absorbance, or other forms of optical state, of the dye caused by the analyte). Wavelengths that may be employed include laser wavelengths of about 405 nm, 650 nm and 780 nm currently used in Blue Ray DVD, DVD and CD players respectively. Embodiments may also include detection of changes in the absorbance max that occur outside the visible range.

A reaction chamber of the present invention may be suited to home or clinic use. Testing may begin by application of a test specimen to one or more test areas on the media, (which may be, without limitation, a CD, DVD, Blu-Ray DVD) which may be demarcated as such in a visible fashion to aid the user of medium in applying the test specimen, if the reaction chamber is not operatively configured to accept and automatically apply the specimen to the appropriate areas on the medium where the test material is found. The Diagnostic digital medium 10 is then inputted into the reception port of the reaction chamber. Once entirely encompassed within the chamber housing, the reaction chamber then automatically dispenses according to software control certain specific reagents on the sample on the test area by use of the external or internal fluidics system as well as alters the environment about the medium such as to automatically incubate according to predetermine protocol. The reagents dispensed should optimally be useful for elucidating the intended analyte or class of analytes in conjunction with the test material and can include substances to facilitate a change in optical state such as an acid generating system and a dye. Of course, any parametric change that is capable of being detected by the reader of the optical medium may be monitored. In one case, when the reagent designed for the specific analyte in the specialized test material engages the analyte, the acid generating system is activated changing the absorption maximum of the dye. This change may result in a change in optics that activates the DVD/CD player indicating the presence or absence of the analyte.

Samples suitable for analysis using the systems described herein include all bodily fluids and tissues, and any environmental liquid or solid. Examples are blood, urine, saliva, feces, sweat, wound exudates, nipple aspirates, etc. Other analytes include, without limitation, water (to check for minerals, contaminates etc.), paint chips, foods, liquids. Liquids in some embodiment may be applied to a test material spot by means of a capillary tube or rod while solids may applied as a smear with or with out a solvent. Or, as discussed above, sample application to the Diagnostic digital medium 10 may occur by way of external or internal fluidics system of the reaction chamber. Specimens gathered from dermal surfaces may be obtained as swipes and applied as a smear to the test area spot 5 (FIG. 6). This includes all bodily orifices such as throat, nose, ear, mouth, anus, vagina, etc and may be applied to the specialized test material spot as a smear.

In an additional embodiment, the sample maybe a thin section of organic or inorganic material fixed to the test area spot 5 of the substrate prior to insertion into the reaction chamber housing.

Instead of each reagent being dispensed from the reaction chamber, or manually applied by a user of the Diagnostic digital medium 10, the substrate may have the specific reagents printed on the substrate.

In one embodiment, particular genes maybe probed using methods of fluorescence in situ hybridization (Fish). This type of analysis is particularly well suited the reaction chamber described herein since multiple washes are required.

Once the specimen and test reagents are applied by the fluidics module of reaction chamber to the test area 5, and incubated according the specific protocol for the intended analyte, a parametric change, such as in absorbance or in opacity may be monitored. This software for control of reagents dispensed, the location of dispensing etc. may reside locally (for example, on the optical medium or in the reader or processor associated with the reader) or it may reside in a remote location accessible through a in-communication port of the reaction chamber (as for example, from a computer connected to a widely disseminated network such as the Internet). Of course, instead of software control, hardware, or a combination of hardware and software may be used. Exemplary software may be designed to interpret the validity of the response as well as to measure the amount as well as the presence or absence of the substance. Validity of response can be a two part process. For example, first, controls are included to assess the reagents included in the test material. That is the specific reagent selected to interact with the analyte contained in the specimen. Secondly, controls are included to validate the integrity of the specimen. For example, combinations of usually stable components in blood such as albumin and phosphatidylcholine can be co-analyzed to verify that sufficient sample is present. The use of multiple test-material spots on the discs permits measurement of intra- and inter-sample analysis reproducibility needed to assess assay quality. Additionally, known interference compounds for each particular analyte can be analyzed. For samples analyzed remotely, comparisons with similar and dissimilar populations can be made to access specificity and sensitivity.

In another embodiment the optical medium includes software that is configured to cause the reader, or a processor connected to the reader, to transmit data pertaining to the read at one or more test area 5 sites associated with the medium, to a remote site over a widely disseminated network, such as the internet along with information pertaining to the IP address of the transmitter. The remote site then may process the information at said one or more test material sites and transmit to the transmitter's IP site a tentative diagnosis and/or transmit a tentative diagnosis to a professional designated by the transmitter.

Utilization of the polymerase chain reaction (PCR) or real-time PCR is one embodiment well suited to said reaction chamber. PCR is a powerful technique used to enormously amplify trace amounts DNA or RNA. PCR analyses proceed by incubating DNA or RNA samples with the proper reverse and forward primers, a thermal-stable DNA polymerase and other reaction components. After the reaction proceeds, the temperature of the reaction mix is increased to temperatures high enough to denature the DNA but not high enough to inactivate the heat-stable polymerase. The temperature is then cycled back down to the reaction temperature and repeated. After many cycles the original DNA or RNA is highly amplified. Because the said reaction chamber facilitates temperature cycling through the control module, the powerful PCR technique is suitable for analysis on a substrate such as an optical disc.

Another embodiment is the detection of biomarkers to enable individuals in a clinical or home setting to predict medical consequences. Biomarkers are generally molecular entities that serve as surrogates of clinical end points. Biomarkers predict risk of disease, success or requirements of therapeutics, and diagnose disease. For example, cholesterol levels and LDL levels correlate with heart disease and the level of Hba1c glycosylation is diagnostic for diabetes. Additionally biomarkers also predict if an individual will respond or not respond to a particular therapeutic. For example, lung cancer patients that over express HER2 receptor may respond to monoclonal antibodies designed to block that receptor such as Herceptin. Biomarkers are also of great value in determining if drugs are engaging the designated target and to what duration the target is engaged. For example, measurement of cyclooxygenase activity in the blood demonstrates to the individual taking aspirin that the drug is working and how long it is working. These biomarkers of efficacy may also be used for infectious diseases to determine microbe eradication needed by health professionals to determine whether to continue or change the therapeutic in a timely fashion. This could be done prior to worsening clinical manifestations with said optical medium. This is of particular importance for individuals in remote areas. DNA or RNA probes may also be included to detect specific entities or patterns that may indicate sensitivity to treatment or disease.

Biomarkers are also useful for determination of “off-target” effects of therapeutics. “Off-target” refers to unintended targets such as enzymes and receptors in the design of the drug. All drugs have “off-target” effects. Some off-target effects are toxic, others have neutral and some contribute to the efficacy of the therapeutic. Knowledge of unique and individual off-target effects are of great value particularly to those with numerous risk factors. Monitoring of toxicity biomarkers can be of critical importance to individuals. Early knowledge of elevated liver enzymes, or elevated lactate dehydrogenase from damaged cardiac tissue or elevated of C-reactive protein in hyperlipodemics can be an immediate signals to seek help and to alter activities.

A further embodiment is the use of conjugated antibodies to identify important analytes. For example an antibody to an antigenic substance such as an important cancer biomarker such as the VEGF receptor maybe analyzed by use of features designed into the reaction chamber. In this case, the sample may be placed on the test area 5 of the Diagnostic digital medium 10 and then inserted into the reaction chamber where the fluidics module maybe instructed to wash unbound antibody from the sample and apply a second antibody directed to the first antibody which is in turn bound to the VEGF receptor. Since the second antibody is conjugated with an acid producing enzyme such as carbonic anhydrase, after addition of the substrate carbon dioxide produces acid in proportion to the amount of VEGF receptor in the sample and changing the color of dye blocking the read function of optical disc reader.

Another embodiment is the diagnosis of diabetes. This could be accomplished in three complimentary ways with the optical medium described herein. Blood or urine glucose can be measured directly in a fasted or fed state. Glucose tolerance may also be measured by including a glucose load and measuring blood glucose in incrementally time intervals before and after the load. Finally, long term exposure to glucose can be made by measuring the degree of the glycosylation of Hb1 Ac. Hb1 Ac measurements are of particular value for diagnosis and determining the severity of diabetes since it is not vulnerable to confounding due to the common fluxuations in plasma glucose. Assessment of these analytes with the optical medium herein, for the diagnosis require the selection of the proper reagents comprising the test material. In this case, chemical or enzymatic reagents can be chosen for glucose and an antibody can be chosen for HbA1c to comprise the test material. For example, as mentioned above, the specialized test material is printed onto the medium (for example CD/DVD). The specimen and appropriate controls are applied to the printed test material spot or spots.

An additional embodiment is a method of evaluating diabetic fitness using a personal diagnostic device. First an initial assessment of diabetic fitness is performed, whereby a baseline panel of results is obtained. In one case of the invention a test sample is taken via an oral swab. Alternately, the user may expectorate a quantity of saliva into a sample tube. The sample is then transferred to a banded test strip by wiping or dipping the banded test strip into the saliva sample. Multiple analyses occur on the banded test strip. Each band of the test strip is impregnated with an analytically specific reaction system, thereby providing a specific quantitative assessment of a separate relevant physiological marker at each band. In one embodiment, at end of reaction, each band would display a color that has been previously quantitatively linked to the level of its marker/analyte in the saliva sample. The user reads the color value of each band and tabulates the value of each marker. In an alternate embodiment, the personal diagnostic device senses the test results automatically, and results displayed according to predetermined correlations of the values of the results and diabetic fitness.

Optionally a blood glucose level is obtained using an independent testing device. The plurality of quantitative measurements, optionally including the blood glucose level, is then combined in a readable panel of results. The significance of the test panel is then evaluated by the- user or automatically by the personal diagnostic.

After obtaining a baseline test panel, the user of the personal diagnostic may the engage in a preferred activity, for example consuming a meal that is attractive to the user, but not necessarily healthy. At a suitable time following the preferred activity, a second test is performed and the results compared with the initial baseline test, indicating the suitability of the meal.

A plurality of test results is obtained over a period of time as chosen by the user. Depending upon the trend of the test results the user has stronger justification to modify the user's diet and determine if the diet is beneficial or harmful. In other words, the user evaluates the significance of the panel results over time and acts accordingly, with the expectation of changing through dietary action user's physiological markers in a preferred direction.

With respect to relevant physiological markers, the following are examples that are important for assessing glucose management and diabetic fitness: insulin levels, catecholamine status, triglyceride levels, carbohydrate levels, respiration quotients, and genetic markers, such a Nhe-1, that suggest a susceptibility to Type 1 Diabetes. Other exemplary markers are salivary pH, ketone level, and electrolyte composition. As envisioned in the instant invention, specific tests for these and other markers may be incorporated in a banded test strip.

Insulin is expressed as a micofiltrate in human saliva, and is correlated with blood insulin levels (1). Thus, salivary insulin is known to be a marker for blood insulin. However, strong variations are seen between individuals. Thus, individualized testing is suggested, as provided by a companion diagnostic device. It is expected that the significance of changes in salivary insulin over time will have to be evaluated on a person-by-person basis.

Catecholamines, such as the hormones epinephrine, norepinephrine, and dopamine, raise blood glucose levels; they are secreted in response to low blood glucose levels and are readily detected in saliva (2) and urine, and may correlate with diabetic fitness, serving as suitable markers

In terms of demonstrating susceptibility to Type 2 Diabetes, Morahan et al. (3) report a putative susceptibility gene, Nhe-1, that implicates the Na+/H+ antiporter in the development of Type 1 Diabetes. In one embodiment of the invention, a salivary marker for Nhe-1 may provide a screening test for at risk individuals and enable disease prevention.

Another exemplary marker of metabolic activity and diabetic fitness is the respiratory quotient. The respiratory quotient can be measured on a sample captured during exhalation. The respiratory quotient is the molar ratio of carbon dioxide released to the oxygen consumed by the user in a given period. It is used to evaluate basal metabolism rate, and to indicate the primary form of the metabolism that is occurring. The respiratory quotient (RQ) is calculated from the ratio:

RQ=CO_{2produced}/O_{2consumed}

In this calculation, the CO₂ and O₂ must be given in the same units, in quantities proportional to the numbers of each molecule.

The range of respiratory quotients for organisms in metabolic balance is usually in the ranges of about 1.0 to 0.7. The first value is that expected for pure carbohydrate oxidation, and the second value is that expected for pure fat oxidation. (the value expected for pure fat oxidation). A mixed diet of fat and carbohydrate results in an average value between these numbers A respiratory quotient above 1.0 usually indicates an organism burning carbohydrate to produce fat stores. In one embodiment of the invention, it is anticipated that the respiratory quotient will be an indicator of diet and diabetic fitness.

Similarly Lyme disease can be diagnosed by designing a specific test material for Borrelia burgdorferi or a pathologically relevant genetic variant. This reagent can be an antibody and the control antibody can be directed to a similar but benign spirochete. Analogously, HIV can be detected and the clinical progression of HIV to AIDs or the success of therapeutic intervention can be similarly monitored with reagents directed towards the virus and CD4+ cells. In each the reaction chamber components, apply sample and specific reagents to the test area of the disc, carry out all steps of the protocol to yield a detectable signal.

Similarly, sexually transmitted diseases such gonorrhea, Chlamydia and infectious diseases may be detected. DNA probes may also be included in the test reagents to detect microbes or lysed microbes. This can be as described above for polymersase chain reactions or for fluorescence in situ hybridization type protocols controlled by the various components of the reaction chamber to deliver a detectable signal on the test area of the substrate.

Another preferred embodiment envisioned enables food and drink safety Assessment. With the origin of foodstuff becoming more difficult to track, food safety is an increasing concern. Sources of food contaminates include processing materials such as glycols, machine oils and degradation products of additives such as cyanates, nitrosamines, etc. Methods of livestock husbandry frequently include the use of steroids and antibiotics. Fish derived from the ocean are at risk of mercury contamination while farm-raised fish are in danger of pesticide contamination from run-off of surrounding areas. Finally most food is susceptible to microbial contamination. Water heavy metal levels and other contaminate levels are required for safe consumption. These and other examples are generally increasing the need for additional safety assessment beyond regulatory agencies. Incorporation of selective and nonselective reagents into the test material for specific and/or classes of contaminates provides the individual a means to verify food and drink safety in a remote or local fashion. Liquids may be assessed as described by direct application with a capillary tube or rod to the test material printed on the disc. Solids may be applied as a smear or after a simple partitioning into liquid and then applying the extract to the test area 5 on the disc. In this case the sample may be applied manually to the test area 5 or by use of the reaction chamber fluidics systems. In either case, the subsequent steps of the protocol are controlled by the components of the reaction chamber to yield on the substrate a detectable signal.

Food quality assessment is another need suited for the reaction chamber described herein. We refer here to food quality as the contribution of the food composition to long term health. Carbohydrates of low glycemic index for example benefit long term health. Generally complex carbohydrates have low glycemic indices because they have slower hydrolysis rates resulting in modest increases in blood glucose which in turn require modest release of insulin for proper homeostasis. Simple sugars such as high fructose corn syrup have high glycemic indices that yield higher concentrations of blood glucose and are related to the endemic increase in obesity and diabetes. Problematic for the individual is the wide spread use of corn syrup in food processing. By choosing reagents selective for simple carbohydrates to comprise the test material, the quality of carbohydrates in common foods can be measured.

Lipids also contribute to food quality. Omega-3 fatty acids have established cardiovascular benefit over saturated fats, trans fats and sterols such as cholesterol. This embodiment provides a means for the individual to access the quality of lipids in their foods. For lipid quality analysis, smears or simple extracts are applied to the test area 5 such as that shown on the DVD or CD shown in FIG. 6. This may be performed manually or by components of the reaction chamber. In either case, the subsequent steps in the protocol needed to develop a signal specific for the desired lipid or lipid class are carried out by components of the reaction chamber. In this case it is logical to include an ozonolysis step in the protocol. Ozone cleaves the double bonds thereby permitting the direct analysis of the omega-3, 6, 9 fatty acids that determine fat quality. Gas control to the substrate bearing the sample is operated by the control module. The reaction chamber is designed to support multi-step protocols such as this.

### ENVIRONMENTAL MONITORING

An additional embodiment configures the optical media to serve as an environmental and security monitor. Paints for example are often required for heavy metal including lead analyses. This is accomplished by including reagents in the test material specific for environmental contaminants, poisons and explosives. Solids may be collected by swiping surfaces or filtering air-born particles and then applying the collected sample as a smear or simple extract to the test area 5 on the disc. Contaminants, poisons and explosives in the form of gases may be sampled by partitioning into filters with active surfaces like charcoal or into ion traps if ionic. Neutral contaminants, poisons and explosives maybe ionized first and then collected with an ion trap. Trapped molecules and particles can then be applied to the test area 5. Again, for this case, the sample maybe applied manually or by the fluidics system of the reaction chamber. In either case, subsequent steps in the protocol including the addition of specific reagents and the chemical and/or physical changes necessary to produce a detectable signal on the substrate are controlled by the reaction chamber.

### EXAMPLE 1

An embodiment is disclosed wherein an optical disc 600, such as a Blu-Ray Disc, may be manufactured with a top coating that reacts to Green House gases. The Green house gases may be indicated by a monitoring dye that is coated at the green 3 μM thick layer 610. After exposure to the environment, a standard optical disc player may be used to read the disc. The results could then be sent via a communications network, such as the INTERNET. to a central database. The database may then be used to aid in tracking Green House gases.

The list of anthropogenic Green House gases as used by the IPCC TAR comprises the following:
1. (Carbon dioxide (CO2) 365 ppm 87 ppm 1.46
2. Methane (CH4) 1,745 ppb 1,045 ppb 0.48
3. Nitrous oxide (N2O) 314 ppb 44 ppb 0.15
4. Tetrafluoromethane Carbon tetrafluoride (CF4) 80 ppt
5. Hexafluoroethane (C2F6) 3 ppt
6. Sulfur hexafluoride (SF6) 4.2 ppt
7. HFC-23 Trifluoroethane (CHF3) 14 pp
8. HFC-134a 1,1,1,2-tetrafluoroethane (C2H2F4) 7.5 ppt
9. HFC-152a 1,1-Difluoroethane (C2H4F2) 0.5 ppt

The acidic nature of carbon dioxide activates a photo acid generator (i.e. DCM-252 Daychem, Ohio) which is a component of the optical disc coating. The dye would be mixed into a gas permeable layer of the optical disc. Upon exposure, the photo acid generator would turn an Acid Yellow or a Gold Dye from yellow to clear.

In another embodiment, the following Green House gas reacting dyes may be printed onto the top surface of an optical disc:
4-96 mg/ml CO2 acid reactor molecule
1-15 mg of Blue Dye-Solvent Blue
80-96% Diethyl Ketone
1-5% poly methyl metharcylate
1-3% methoxy propanol

A VideoJet Excel Printer is suitable for applying the dye to the optical disc. The disc may be wrapped in a gas exchange proof wrapper for shipping.

### EXAMPLE 2

In an embodiment key aspects of the preparation of a suitable optical disc associated matrix is described. For surface reactions (surface etching) on optical discs, a matrix that allows bio-active and chemical markers to be anchored to the surface of an optical disc is implemented. Etching reactions into PC are cyclopentanone, etc, etc. To maintain biological activity or reactivity, a marker is etched onto the surface or sub layer of a polycarbonate DVD or a Hard Coat Blu-Ray Disc. Surface etching is key first step when anchoring or multiplexing the detection molecule to the colorimetric part of the molecule. For example, the capture antibody is immobilized on/in the optical discs using the following etch chemistry:
1.8 ml of cyclopentanone
0.2 ml of polymethyl methacrylate in methyl ethyl ketone (MEK)
100 mg/ml of a photon acid generator
11 mg/ml of blue dye (very soluble in cyclopentananone) or a dye-antibody for one of the above mentioned biomarkers.

and the tracer colormetric dye is then attached or may be attached to the detection molecule before attachment. The colormetric dye is 650 nm light blocking for DVD discs and bioactivity during shipping and high heat conditions. Heat stable, single domain antibody from sharks and llamas have simple and robust protein structure and can maintain their structure in high heat temperatures (Liu, J. L. et al Mol Immunol (2007) 44, 1775; Goldman, E. R., et al., Anal. Chem. (2006) 78,8245; Andreotti, P. E. et al., Bio Techniques (2003) 35,850. This becomes Key for the surface markers to be maintained through repeated washing steps. The multiple arrays make the live cell detection possible. These types of test can be quite problematic when non-living cells and pathogens are detected. Double and co-markers can be etched in the same surface to determine live cell activity.

Any gas or fluid, such as tears, blood, buccal swipe, urine etc. can be reacted with the surface. The problem has always been metered.

For Blu-Ray (BD) Discs the inner ring closest to the center hub is called the burst cutting area (BCA). The BCA area on the BD disc or the lead in area of the DVD (23.5 25 mm radius). Adding these material to this area initially causes the disc not to read or play. The reaction to the biomarker/s causes the material to turn from OD˜0.500 405 nm (BD); ˜OD 0.500 650 nm (DVD). Once activated by reacting with the one of the target materials, the OD will convert to <0.05 AU (650 nm DVD) and <0.05 AU (405 nm BD).

Metered Application:

1. Dimatix Fuji ink cartridge that can hold a medical sample mix and insert: The FujiFilm Dimatix cartridge Model#DMC-11610 PN 700-10702-01 can be used to mix the test material with the indicator material. A Drop on Demand ink cartridge can be placed into the (external disc reaction (EDR)device to hold the disc separate from the disc drive.

2. Another embodiment it can be a swap or market type applicator. PCR (endpoints from ˜30 min to 1 hr) applications have allowed assays that detect from fluids from water, food, mouth/cheek swab, urine, blood, and most recently tears (Elnifro, E. M., et al., Clin. Microbiol. Rev. (2000) 13, 559; Paton, A. W., and Paton, J. C., J. Clin. Microbiol (1998) 36,598; Richards, B., et al., Hum. Mol. Genet. (1993) 2, 159; Stockton, J. et al., J. Clin Microbiol (1998) 35, 2990.

3. Colormetric endpoint

4. External Disc Reactor (EDR)

Mixing and Incubation:

1. Issues microfluidic channels.

2. Mixing and repeated washing steps

3. Reactions at different temperatures-

Energy to Drive the Endpoint Reaction:

1. UV driven complete reaction.ns-

2. Colormetric endpoint using photo acid generators to drive calorimetric changes after binding with detection down using sandwich assays with limits of detection (LODs) down to 0.1 ng to 200 ng/ml range for proteins to 103-105 colony forming units/ml bacteria.

Flash UV sterilization after endpoint reaction:

1. UV sterilization Inside the EDR is UV flash lamp (Xenon Systems) that provides for UV sterilization of the disc and device before the disc is removed and carried away of placed into a standard DVD player to be read by the computer.

### EXAMPLE 3

In an embodiment, applicable to environmental monitoring in the housing and real estate industries, a portable indicator of lead paint is presented. Indicator sticks, or stickers, that change color from white to red or pink, for example, when rubbed against lead containing paint, provide an instant indication of lead contamination. The stick or sticker is coated on one side with an adhesive that is intermixed with a material that is capable of indicating the presence of lead. The presence of lead is indicated by change of color of the adhesive/lead indicator mixture from its normal color to another, for example from white to red or pink. Such a sticker may be adhesively affixed to a painted article, thus giving an instant indication of the lead content of the paint covering the article.

The sticker can furthermore contain other information printed, thereon, such as the price of the article, thus serving both as a lead paint indicator and a price label.

### STATEMENT REGARDING PREFERRED EMBODIMENTS

While the invention has been described with respect to preferred embodiments, those skilled in the art will readily appreciate that various changes and/or modifications can be made to the invention without departing from the spirit or scope of the invention, in particular the embodiments of the invention defined by the appended claims. All documents cited herein are incorporated in their entirety herein.

1. A test carrier for detecting analytes comprising:
an optical media having a planar read side surface and a data side surface;
a specialized test material for an analyte applied on or in at least a portion of said read side surface; and
said specialized test material comprising material which changes the state of at least one optical characteristic in response to contact with said analyte.

2. A method of detecting an analyte contained in a specimen comprising:
obtaining said specimen;
providing an optical medium incorporating a specialized test material for an analyte;
applying said specimen to said specialized test material on or in said optical medium;
reading said optical medium on optical player; and
detecting presence of said analyte compound using data read from said optical medium.

3. A method of manufacturing an optical medium comprising:
obtaining an optical medium including pre-recorded data;
printing a specialized test material on or in at least a portion of the said optical disc.

4. A disc readable by an optical disc reader comprising:
a circular substrate having an upper surface and a lower surface;
at least one test site located on said upper surface configured to receive a biological sample;
said at least one test site containing a test material that interacts with said biological sample;
said disc containing software to command processor to search said disc for said test sites and analyze characteristics at said test sites.

5. A method, using a companion diagnostic device, for assessing and modifying physiological status comprising:
obtaining a first physiologically relevant sample and delivering said sample to the companion diagnostic device for analysis;
analyzing said first physiologically relevant sample;
evaluating the physiological significance of one or more assay results produced by said companion diagnostic device, each of said assay results representing a valid, quantitative measurement of a physiological marker relevant to physiological status;
engaging in an activity that may affect the physiological status;
obtaining a second physiologically relevant sample and delivering said second sample to the companion diagnostic device for analysis;
analyzing said second physiologically relevant sample;
again evaluating the physiological significance of one or more assay results produced by the companion diagnostic device upon analysis of the sample, each of said assay results representing a valid, quantitative measurement of a physiological marker appropriate for assessing the physiological status;
assessing the change in physiological status by comparing the results of the analysis of said first sample with analysis of said second sample; and
modifying said activity based upon the change in physiological status.

6. The method of claim 5 wherein the physiological status is diabetic fitness.

7. The method of claim 5 wherein the said sample is saliva.

8. The method of claim 5 wherein the said sample is urine.

9. The method of claim 5 wherein the said sample is fecal matter.

10. The method of claim 5 wherein the said sample is exhalate.

11. The method of claim 5 wherein said physiological marker is insulin.

12. The method of claim 5 wherein said physiological marker is selected from the group consisting of a catecholamine, a triglyceride, a carbohydrate, a gene, salivary pH, a ketone, and an electrolyte.

13. The method of claim 5 wherein said physiological marker is the respiratory quotient.

14. The method of claim 5 wherein said samples are sent to a remote testing site for analysis and the results are communicated back.

15. The method of claim 5 wherein the companion diagnostic device comprises a plurality of bands impregnated on a test strip, wherein each test strip comprises a reaction system selective to essentially one appropriate physiological marker, wherein each reaction system produces a result that is quantitatively associated with said appropriate physiological marker.

16. The method of claim 5 wherein said assay results are displayed in table form.

17. An apparatus facilitating the reaction of an analyte with a test material on a digitally-readable medium to yield a detectable signal readable by a reader of the digitally readable medium, said apparatus comprising:
a sealed housing encompassing a void, said housing void structurally dimensioned to enclose said digitally-readable medium;
a entrance port providing communication between the environment ambient to said enclosed housing and said void of said housing, said entrance port operatively configured to permit said digitally-readable medium to pass through said entrance port into said void of said housing, and to keep said housing sealed against the ambient environment outside of said entrance port;
at least one fluid pump module having an a fluid reservoir exterior to said housing, and a conduit communicating with said void of said housing;
a processor operatively coupled with said housing, said processor controlling said at least one fluid pump module to dispense fluid from said fluid reservoir into said void of said housing;
at least one detector configured to detect when said void encompasses said digitally-readable medium, and to detect conditions within said void of said housing;
an instruction set configured to control said processor to time dispensing of said fluid into said void of said housing according to said test material on said digitally-readable medium.

18. The apparatus of claim 17 wherein said digitally-readable medium comprises an optical disc selected from the group consisting of: a Blu-Ray, HD, DVD, CD disc.
